(19) United States
(12) Patent Application Publication
(10) Pub. No.: US 2025/0045461 A1
(43) Pub. Date: Feb. 6, 2025

(54) SYSTEM AND METHOD FOR COMPROMISED ASSET DETECTION

(71) Applicant: Illuminate Security Pty Ltd, Concord (AU)

(72) Inventor: Shaun James Vlassis, Concord (AU)

(73) Assignee: Illuminate Security Pty Ltd, Concord (AU)

(21) Appl. No.: 18/753,388

(22) Filed: Jun. 25, 2024

(30) Foreign Application Priority Data
Jul. 31, 2023 (AU) 2023902421

(51) Int. Cl. G06F 21/64

(52) U.S. Cl. CPC G06F 21/64

(57) ABSTRACT

Embodiments of the present disclosure provide a method of detecting compromised digital assets of a data owner, the method comprising the steps of selecting a digital asset data of the data owner, uploading selected owner data to a receiving system, identifying, by said receiving system, predetermined data types of the uploaded owner data and performing on identified data types one or more selected sequentially from the group consisting of: redacting owner specific data, scrubbing predetermined common data, and tokenising predetermined data; assessing and certifying the accuracy of the redaction, scrubbing and tokenisation of the data and producing prepared owner data; and preferably enriching the prepared owner data; defining, on the receiving system, reward rules for detection of compromised prepared owner data including a tangible reward; subscribing one or more predetermined registered third party analysts to the prepared owner data; receiving by the receiving system, from at least one subscribed analyst, a compromised data report indicating one or more compromises of the prepared data; validating by the receiving system the received compromised data report; sending, by the receiving system, data indicative of the compromised data report to the data owner; and facilitated by the receiving system transfer of the reward to the subscribed analyst.

### CROSS-REFERENCE TO RELATED APPLICATIONS

This application claims priority to Australian Provisional Patent Application No. 2023902421, filed Jul. 31, 2023, the contents of which is incorporated herein by reference in its entirety.

### FIELD

The invention relates to securing digital systems and, in particular, to a system and method for detecting compromised digital technology assets.

The invention has been developed primarily for threat detection of digital systems that have large volumes of data and will be described hereinafter with reference to this application. However, it will be appreciated that the invention is not limited to this particular field of use and is useful in responding to detected threats.

### BACKGROUND

Most modern enterprises rely heavily on computerised systems. All facets of operations are typically centrally accessible whether by enterprise located computing systems or via the cloud. With this, information of all forms for an enterprise is stored in a manner designed to be accessible and secure.

The data of an enterprise is often not typically their own, including for management, but includes information sensitive to the enterprise's clients, whether personally or commercially sensitive. It is well known that this type of data can have damaging effects for an enterprise if it is released publicly or to a competitor, or when it is made unavailable such as through encryption or wipe-ware attacks.

Given the obvious need for security of data, many levels of security are used including via mechanisms built into software and operating on the computing systems. These are known to be configured to scan for known virus definitions, for example, but offer no protection against zero-day threats. Other than basic defence of access to computer systems, it can be extremely complex and time consuming to determine if an enterprise's computer systems have been compromised without undesirable effects becoming evident, for example, an extortion note from a hacker.

Being difficult to determine that a system has been compromised, some organisations employ a specialised team or tools to search out unusual activity that may be an indication a system has been compromised. The skillset for such a forensic examination is highly specialised and relatively rare and accordingly expensive to the extent that even large enterprises cannot locate necessary expertise and retain them for detecting compromised systems. It is often the case that either specialised forensic service providers or exceptionally large companies can locate and afford such staff but also provide them with sufficient on-going work.

Further, it is not unusual for specialised teams large or small to be technically deficit or weak in one or more aspects. Also, it will be appreciated that the resources required increases with the volume of data under consideration and often use of security rules that increase in number with data size results in outcomes having unacceptably high falsely identified threats or compromises. False ‘positive’ results in known threat detection can be as high as 95%. It is known this significantly reduces an enterprise's return on cost invested in the detection and limits cost effectiveness of any threat response remediation.

This inability extends also to the use of third party contractors for many companies simply in the face of the expense. This results in some companies merely not considering detecting threats to their digital systems, and others not engaging contractors frequently enough, or even not investigating entirely across a company's systems.

### OBJECT OF INVENTION

The object of the invention is a desire to overcome or substantially ameliorate one or more of the disadvantages of the prior art, or to provide a useful alternative.

### SUMMARY OF INVENTION

According to an aspect of the invention there is provided a method of detecting compromised digital assets of a data owner, the method comprising the steps of:
selecting digital asset data of the data owner;
uploading selected owner data to a receiving system;
identifying, by said receiving system, predetermined data types of the uploaded owner data and performing on identified data types one or more selected sequentially from the group consisting of:
   redacting owner specific data, scrubbing predetermined common data, and tokenising predetermined data;
   assessing and certifying the accuracy of the redaction, scrubbing and tokenisation of the data and producing prepared owner data; and
   preferably enriching the prepared owner data;
defining, on the receiving system, reward rules for detection of compromised prepared owner data including a tangible reward;
subscribing one or more predetermined registered third party analysts to the prepared owner data;
receiving by the receiving system, from at least one subscribed analyst, a compromised data report indicating one or more compromises of the prepared data;
validating by the receiving system the received compromised data report; sending, by the receiving system, data indicative of the compromised data report to the data owner; and
facilitated by the receiving system transfer of the reward to the subscribed analyst.

It can be seen there is advantageously provided a system and method to allow under-resourced entities to access the full spectrum of expertise in data asset threat detection, and also potentially expands system detection opportunities and allows for the provision of a response. Furthermore, the method allows owner data to be securely disclosed for investigation but where sensitive data is removed. This can provide a significantly improved return on threat detection investment and can not only identify that remediation is required but allow it to be conducted in a most cost effective manner.

### BRIEF DESCRIPTION OF DRAWINGS

A preferred embodiment of the invention will now be described, by way of example only, with reference to the accompanying drawings in which:

FIG. 1 is a schematic depiction of a system for operating a method for compromised digital asset protection according to the preferred embodiment;

FIG. 2 is a flow chart setting out data preparation steps in the method of FIG. 1;

FIG. 3 is a schematic of the system of FIG. 1 implemented using AWS;

FIG. 4 is a decision tree for determining data inclusion in the method of FIG. 1;

FIG. 5 is a decision tree for determining subscribed analyst access to owner data in the method of FIG. 1;

FIG. 6 illustrates subscriber access to prepared owner data of the method of FIG. 1;

FIG. 7 is an example of data prepared according to FIG. 2;

FIG. 8 is an example of an analyst assertion report in the method of FIG. 1; and

FIG. 9 is an illustrative example of an environment in which preferred embodiments of the invention can be implemented.

### DESCRIPTION OF EMBODIMENTS

Referring to the drawings generally, there is shown a system and method for detecting and responding to compromised digital assets of a data owner and allowing subsequent remediation of the compromise. Hereinafter the following terms are used in the description of the preferred embodiment.

| | |
|---|---|
| Log Data/ | Log data, also known as log files or simply logs, refer to the automatically |
| Telemetry | produced and time-stamped documentation of events relevant to a |
| | particular system. Virtually all software applications and systems produce |
| | log files, not to mention web servers and operating systems. |
| | Used by security professionals to identify compromise of host (system) data, |
| | application (software) data and network (activity) data. |
| Finding | An alert/assertion based on an understanding of attack patterns that present |
| | themselves within a set of telemetry data for a given computer, group of |
| | computers on a given network |
| Campaign | A logical grouping of provided and prepared telemetry data and approved |
| | analysts to access the prepared telemetry data. |
| Platform | The platform (also Bluehat Platform) that facilitates the collection, |
| | preparation and distribution of telemetry data from companies to trusted |
| | groups of analysts. |
| Data | The software tool that processes raw telemetry data and prepares it using |
| Preparation | multiple techniques to be safely shared with trusted groups of analysts. |
| Tool | |
| Tokenisation | The process of extracting, computing and replacing the originally extracted |
| | text with a computationally generated token to enable anonymisation of |
| | telemetry data. |
| Redaction | The process of identifying and removing specific company defined pieces of |
| | information from telemetry data. |
| PII Scrubbing | The process of identifying and removing PII style information from |
| | telemetry data. |
| Network | A grouping of technology assets. |
| Analyst | Cyber Security professional that is focused on threat detection. Identifying |
| | malicious activity in log data and being subscribed to the Platform. |
| Enrichment | Contextual information for a given asset |
| | (user/system/network/application/data) that enhances the understanding of the |
| | role and or importance of the asset |

Generally, the preferred embodiment enables an organisation to provide telemetry data to an independent platform where the data is prepared for sharing safely after understanding what the data is, stripping unwanted information and performing multiple anonymisation techniques. A monetary and/or reputational reward is made available to analysts that successfully identify compromised data and analyst access or subscription criteria is defined for the owner data. The data owner receives findings from the subscribed analyst(/s ‘community’) and those findings are validated. Rewards are then distributed to the analyst/s.

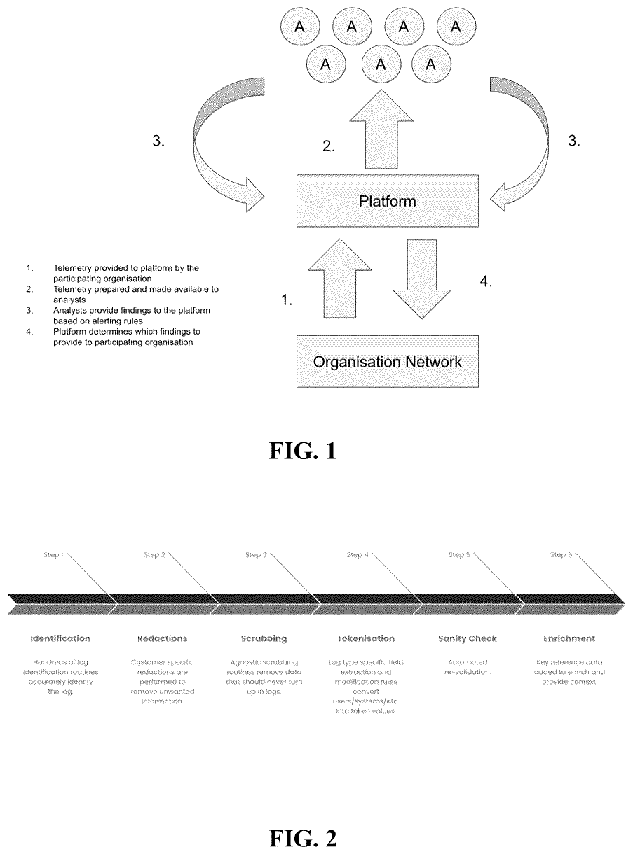

FIG. 1 schematically sets out a system for effecting the method. Particularly, the method includes an owner of digital asset data to select data to be analysed for compromise. This data is uploaded to a receiving system described in the preferred embodiment as the Blue Hat Platform. Once received, the platform identifies predetermined data types of the uploaded owner data and sequentially performs steps to anonymise that owner data. This is shown in FIG. 2 of the preferred embodiment.

To the owner data, this includes redacting owner specific data, scrubbing predetermined common data, tokenising predetermined data, assessing and certifying the accuracy of the redaction, scrubbing and tokenisation of the data and producing prepared owner data, and enriching the owner prepared data.

Once completed by the platform, reward rules for detection of compromised prepared owner data including a tangible reward are defined as selected by the data owner. One, or more forming a community, of predetermined registered third-party analysts are subscribed to access the prepared owner data.

Upon review, at least one subscribed analyst uploads to the platform a compromised data report indicating one or more compromises of the prepared data. Rectification of owner data systems can then be made accordingly. The received compromised data report is validated by the platform, as described below, and data indicative of the compromised data report is sent to the data owner whereby the platform also facilitates transfer of the reward to the subscribed analyst.

The method of receiving, preparing and making available the telemetry data to a campaign involves the challenge of trusting 3rd parties with their telemetry data for the purposes of cyber threat detection services. Today these issues are addressed by ensuring that the processing environment and the people that access and use the telemetry in said processing environment are secure to ensure that the confidentiality and integrity of the telemetry data is maintained to the standards and expectations of the organisation that is relying on the 3rd party to perform the detection function.

This however has shown to not be effective as these 3rd party providers themselves are subject to cyber attacks and as such when they are victims themselves the impacts to their customers are felt also.

Fundamentally access to the telemetry data in its ‘raw form’ as provided by the customer organisation is required. Be it through a processing system/application or at the review stage itself when a potential security issue has been identified. As such any compromise of the organisation that is performing these cyber threat detection services also leads to the compromise of the customers telemetry data as an attacker will simply obtain the same credentials to access the data as would an authorised individual or system as part of the delivery of their service.

A database table representing a collection of log identification routines exists on the platform, and an application that takes the logic as defined in the previously named database table also exists. Telemetry data is provided to the application to be identified. The application runs the list of identification logic provided to attempt to assign a label to the telemetry data for the purposes of identifying what type of telemetry it is.

The application will convert the original data into a JSON object with the original raw data becoming one of the elements. Raw Message originally is “Hello I am a log Message” The JSON then is passed to the next routine. In the example of the preferred embodiment this is:

After the identification routine it becomes

{
“LogType” : <Type of Log from the database of identifiers>,
“LogId” : <cryptographic hash of the RawMsg>”,
“RawMsg” : “Hello I am a log Message”,
“CollectedTimestamp” : <Timestamp in UTC of when the data was
processed>
}

The platform includes a database table representing a collection of redaction routines. An application that takes the logic as defined in the above identification database table is also provided on the platform. Telemetry data, in JSON form of the preferred embodiment, is provided to the application to be redacted based on the defined logic.

The application runs the list of identification logic provided to attempt to identify any matches to the defined search criteria to the telemetry data for the purposes of identifying what type of redaction should be performed. Once an identified component of the RawMsg is identified it is replaced with the defined replacement string and in this example, REDACTED.

As an example, a redaction rule looked for the word “Hello”. For the data in the example above, it would become the following. Another element to the JSON is added to identify the fact that a redaction routine was performed.

{
“LogType” : <Type of Log from the database of identifiers>,
“RawMsg” : “REDACTED I am a log Message”,
“LogId” : <cryptographic hash of the RawMsg>”,
“CollectedTimestamp” : <Timestamp in UTC of when the data was
processed>
“Redaction” : “Has been performed against the RawMsg”
}

As shown in FIG. 2, a scrubbing routine is then performed on the owner data. A database table representing a collection of scrubbing routines is provided on the platform. An application that takes the logic as defined in the identification routines above is also provided.

Telemetry data in JSON form is provided to the application to be scrubbed based on the defined logic. The application runs the list of identification logic provided to attempt to identify any matches to the defined search criteria to the telemetry data for the purposes of identifying what type of scrubbing should be performed. Once an identified component of the RawMsg is identified it is replaced with the following string “Telemetry Message contains PII and has been scrubbed”.

As an example, a redaction rule looked for the word “log Message” For the previously listed data it would become that shown below. Further, another element to the JSON is added to identify the fact that a scrubbing routine was performed. It will be noted that the JSON then is passed to the next routine if no scrubbing rules match.

{
“LogType” : <Type of Log from the database of identifiers>,
“RawMsg” : “Telemetry Message contains PII and has been scrubbed”,
“LogId” : <cryptographic hash of the RawMsg>”,
“CollectedTimestamp” : <Timestamp in UTC of when the data was
processed>,
“Redaction” : “Has been performed against the RawMsg”,
“Scrubbing” : “Telemetry Message contains PII and has been scrubbed”
}

Subsequently, a data tokenisation routine is performed by the platform. In the preferred embodiment, an assumption is made that no scrubbing was performed in the step above. Similarly to the above steps, a database table representing a collection of tokenisation routines is provided.

An application that takes the logic as defined in the identification routines above is also provided. Telemetry data in JSON form is provided to the application to be redacted based on the defined logic for a given telemetry type.

Once an identified component of the RawMsg is identified it is captured and sent to the token generation routine. The returned token is then used to replace the identified string. The returned token and the original field are stored in a database table for identification purposes described further below.

An example for a tokenisation routine check “I am a log (?<Capture>S+)”. For the previously listed data it would become the following.

{
“LogType” : <Type of Log from the database of identifiers>,
“RawMsg” : “REDACTED I am a log T-Data-Tokenstring”,
“LogId” : <cryptographic hash of the RawMsg>”,
“CollectedTimestamp” : <Timestamp in UTC of when the data was
processed>
“Redaction” : “Has been performed against the RawMsg”
}

This data is then assessed and certified for accuracy of the redaction, scrubbing and tokenisation of the owner data. The platform includes a database table of all previously identified and approved tokens with associated, in the preferred embodiment, clear text. An application that takes the logic as defined in the redacted database table exists. Telemetry data in JSON form is provided to the application to be tokenised based on the defined and known clear text fields that were tokenised.

The application iterates through all known clear text fields in the unstructured or structured RawMsg looking for potential misses in previous tokenisation rules that were performed (such as a free text field with no defined or knowable structure). Any identification of a matching string is replaced with the associated token for that string.

In the preferred embodiment, a copy of the telemetry is stored in a platform database table as a new opportunity to enhance the existing tokenisation routine database for what was missed thus leading to a self learning system for this problem. This provides validated JSON data.

Lastly, the validated JSON data is then enriched. A database table of the platform is provided and represents a collection of enrichment routines. An application that takes the logic as defined in the validated database table exists. Telemetry data in JSON form is provided to the application to be enriched based on predefined logic.

A platform application runs the list of identification logic provided to attempt to identify any matches to the defined search criteria to the telemetry data for the purposes of identifying what type of enrichment should be performed. Once an identified component of the RawMsg is identified a new element is added to the JSON to enrich the contextual information about the telemetry data.

As an example, an enrichment rule looks for the word “Hello” which then adds the meaning of the word. For the previously listed data it would become the following:

{
“LogType” : <Type of Log from the database of identifiers>,
“RawMsg” : “REDACTED I am a T-Data-Tokenstring”,
“LogId” : <cryptographic hash of the RawMsg>”,
“CollectedTimestamp” : <Timestamp in UTC of when the data was
processed>
“Redaction” : “Has been performed against the RawMsg”,
“Enrichment” : “Hello is a term of greeting”
}

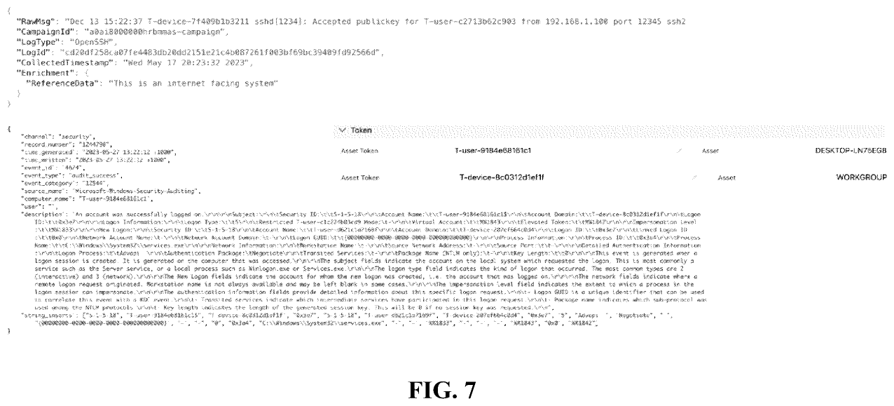

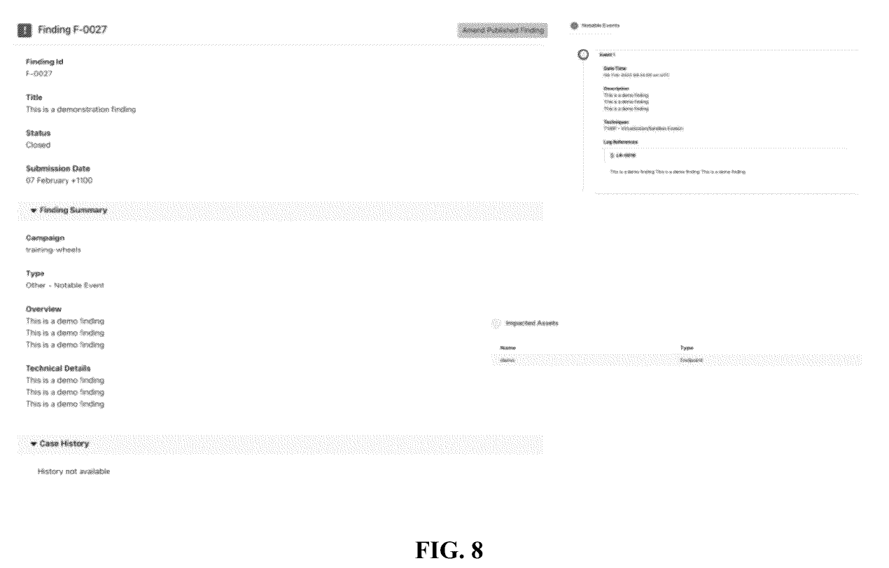

FIG. 7 illustrates an example of some owner telemetry data that has been prepared according to the method of FIG. 2. FIG. 8 illustrates one preferred embodiment of the presentation of an analyst assertion report/findings.

Data owners in the preferred embodiment desire explicit control over what data is to be presented to a group of analysts based on the requirements of their detection & response goals they wish to achieve. The volume of data being provided to a campaign as well as multiple campaigns that an analyst may gain access to means that a unique access methodology must be implemented to ensure that they can explicitly select what information they want to obtain to process and run their rules against. If not implemented there would simply be too much telemetry data for an analyst to collect and then decide what to process so providing clear means for the analyst to selectively identify what to obtain in an automated fashion is required to make this scalable for analysts to subscribe to and provide findings for multiple campaigns from organisations.

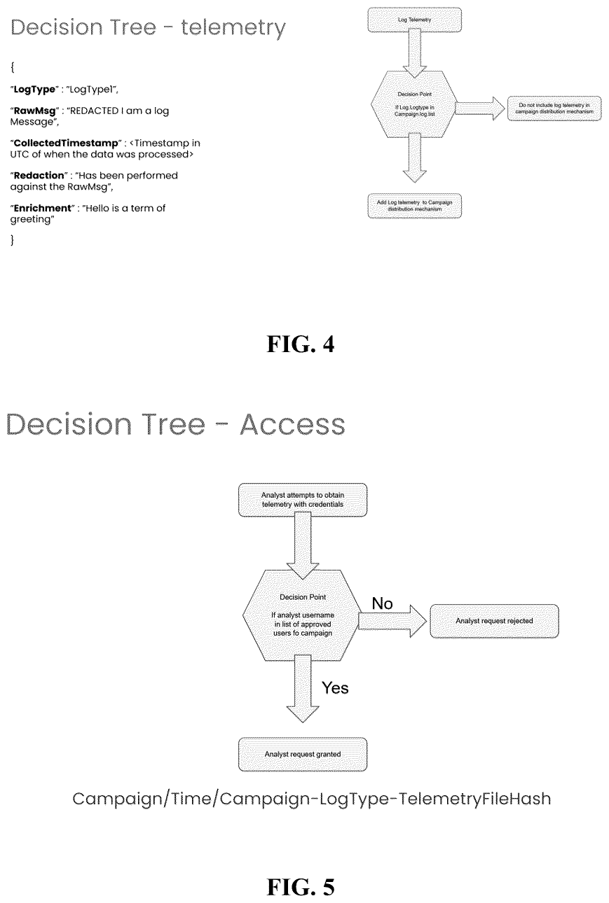

Referring to FIGS. 4 & 5, the Log type field is utilised to “scope in” telemetry data for a given campaign. This provides a safe method given it is explicitly known what each piece of telemetry is from the prior stage of preparing the telemetry itself. Unless the telemetry data was understood and matched the criteria to assign an identification label it shall not be in scope to inclusion in a campaign.

Once a piece of telemetry is identified it is grouped by a period of time and then placed in the folder. In the preferred embodiment, the naming convention is as follows: YYYY/MM/DD/HH/SS/CampaignID-LogType-GroupingHash.tgz. At the same time as the log is placed in a folder a message is also sent to a message bus that analysts can subscribe to if allowed for a given campaign. They then can identify the type of log based on the filename log type identifier itself and based on this know the location of the log message itself.

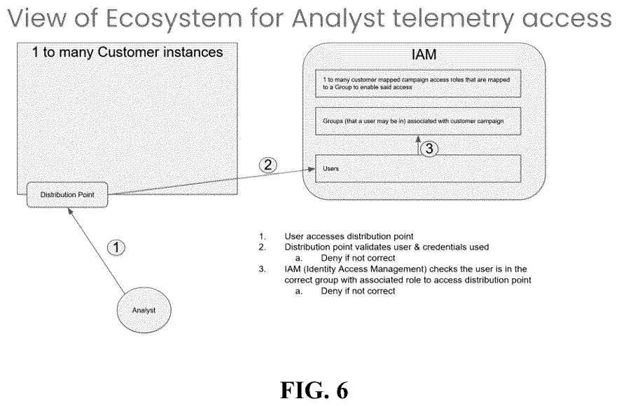

Access to the campaign telemetry distribution mechanism is based on an approved list of users. The Decision Tree is set out in FIGS. 4 & 5, with the access system for the subscribed analysts shown schematically in FIG. 6.

In the preferred embodiment, the step of assigning financial or reputational impacts for a given finding for a campaign are provided. It is noted that a reward may include a fine or negative consequence to deter inaccurate analyst results.

In a pay for detected threat, what is considered an acceptable reward is to be identified and maintained commensurate with the efforts of a given analyst to identify compromise with a customer's provided telemetry data. In the method, it is understood a subscribed analyst will require reward for at least: time spent performing research & development of detection rules; implementation and management of the detection rules; and also reporting or submitting the analyst threat detection assertions (findings).

In respect of the data owners, a range of factors will determine the type and quanta of the rewards including payment specification for a given threat, maturity of security controls for a given data owner, the size of the infrastructure for a data owner in scope for the campaign, and often the threat profile of the given customer.

It will be appreciated that reward options in the preferred embodiment can include any of the following: financial; costs associated with analyst threat detection assertions; analyst reputation or position of influence relative to other analysts including based on confirmed threat detection activities and conveyed expertise/skill level.

Further, a data owner may have considered allocation of reward options depending on the accuracy of an analyst finding, including false positives, completion time, thoroughness of assertions, and considering any communication with the analyst during the submission and validation of the finding submission.

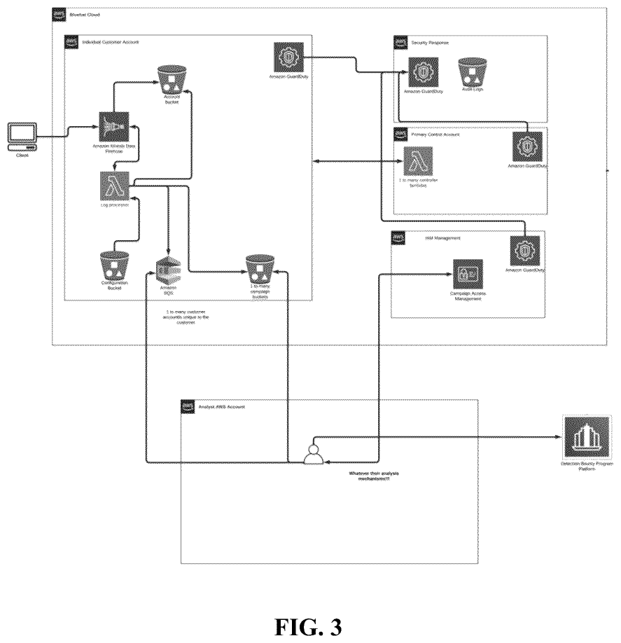

FIG. 3 provides a schematic overview of the system of the preferred embodiment being implemented using Amazon Web Service (AWS), a leading technology hosting cloud provider. The system allows data owners to forward telemetry to the receiving system which may be implemented either through Amazon Firehose OR Amazon S3.

In the flow, data received is then processed and prepared as above:
A. Prepare data including identification, redaction, scrubbing, tokenisation and validation;
B. Decide based on data owner specified criteria what logs to place within a campaign distribution mechanism to, in this case, Amazon S3 bucket;
C. Send a notification message to an event bus, implemented on Amazon SQS, to notify subscribed analysts of new owner dataset/s being made available;
D. Store a customer copy of both the original, and what was provided to the campaign bucket for analyst distribution, message in a ‘customer bucket’; and
E. Subscribed analysts access telemetry data once processed by the receiving system & processing platform;
F. Subscriber access is validated against an identity management system, implemented on Amazon web services IAM solution in the preferred embodiment.

The method of the preferred embodiment also provides that customers providing telemetry data have trust in the analysts that are accessing the data, the same level of checks and further checks are required to provide the sense of security in their minds that the necessary controls and checks are in place.

Elements of a subscribed analyst identity can be validated and measured including by one or more of email account ownership, social media verification, government identification, biometric recognition & association with corresponding government identification, and a criminal background check. Of course, verification of any academic qualifications can also be made. Furthermore, in the preferred embodiment, the analyst trust level can be dynamically altered based on many factors including the number of campaigns subscribed by the analyst and time for which the subscribed analyst has been an active participant such as a defined assessment window period, determining whether the analyst is an active or passive participant, the accuracy and scores from validated findings for correctness or error-rate, for example.

It is understood there may be 1000's of data owner customers each providing 100-1000 GB+ of telemetry a day with 100-500 analysts submitting findings. An approach to ‘triaging’ these findings in an automated fashion considers the following difficulties:
1. Too many findings (alerts) are submitted per day that can't be triaged in a reasonable period for notifying a customer.
2. Findings are of poor quality from a grammatical, professionalism and structural perspective.
3. Findings are incorrectly submitted to a campaign.
4. Findings are submitted with incorrect data structures required.
5. Assertions of the Findings are not supported by the telemetry data and explanation provided.
6. Findings are submitted with fabricated telemetry data to obtain reward for notification.
7. Findings are disputed by the customer as true assertion of compromise.
8. Findings are not understood by the customer due to multiple reasons.
9. Customers react poorly to the identification of compromise.
10. Findings are submitted for an already identified compromised asset within the 1st taker window.
11. Findings are submitted for an already identified compromised asset after the 1st taker window for the same issue.
12. Findings are submitted for an already identified compromised asset identifying failed remediation or re-infection.

The preferred embodiment addresses this by providing assessed data for details including integrity, professionalism, completeness and assertion.

In integrity checking the following process is employed:
1. Access Approval
   a. The UserID of the submitter is checked against the approved list of users that can access the campaign in the first place.
   b. If they are not in the list of approved users, the submission is rejected.
   c. Otherwise, the next stage of the integrity checks is performed
2. Submission structure verification
   a. The structure of the submission itself is compared to the accepted format and data types for each component of the finding submission
   b. If the structure of the submission is not accepted the submission is rejected
   c. Otherwise, the next stage of the integrity checks is performed
3. Fabrication detection
   a. The individual telemetry data for the finding, located in the RawMsg field, is cryptographically hashed with the same mechanism used to produce the LogID hash that is also in the submitted telemetry data structure.
   b. The submitted RawMsg computed Hash is compared with the LogID hash to ensure that the two match.
   c. If they do not match then there has been a fabrication attempt and the submission is rejected

Professionalism checks include:

### Profanity Detection

A. Load a list of known profanity keywords into a table and compare all submitted text
B. If there are matched profanity words then set the profanity flag on the submission for human verification as it may be part of the telemetry data.

### Grammatical Verification

C. All human written components of the finding are checked for grammatical errors and spelling mistakes.

Concerning the completeness check, the following is preferred:

### Field Submission Completeness

A. Ensure that the fields of the structure meet the expectations of a finding
   (i) Length checks
   (ii) Sub structure checks (i.e. JSON for the submitted telemetry in the preferred embodiment)

### Campaign Telemetry Validation

B. Each submitted piece of telemetry is validated to have been part of a campaign
   (i) If a piece of submitted telemetry is not seen in the list of submitted telemetry for a campaign then reject the submission and return to the submitter
   (ii) If all are validated as part of the campaign listed telemetry data then progress to the next phase of checks.

If a piece of submitted telemetry is not seen in the list of submitted telemetry for a campaign then reject the submission and return to the submitter.

Lastly, conducting the assertion checks involves:
1. Telemetry supports finding assertion
   a. Using our database of known telemetry for given attack types validate that the telemetry provided meets the criteria for what is being asserted as a finding type
      i. If it does not then raise a flag for review and potential rejection
2. Assets listed are reflected in telemetry provided
   a. Using the listed assets in the finding structure compare with the telemetry data also provided in the finding submission
      i. If there are no matches for the asset type then reject the submission
      ii. Otherwise progress to the next check types
3. Prior submission check
   a. Using the listed assets and finding type assertions in conjunction identify whether the asset type has already been raised with the owner of the system
      i. If criteria met notify the submitter that this has already been raised
      ii. Else re-raise the submission with the owner of the system
         4. Ecosystem validation
   For the Finding type from the analyst compare the responses from other submissions in different campaigns for the responses from customers if they exist add the validation of the finding trust for representation to the owner of the system.

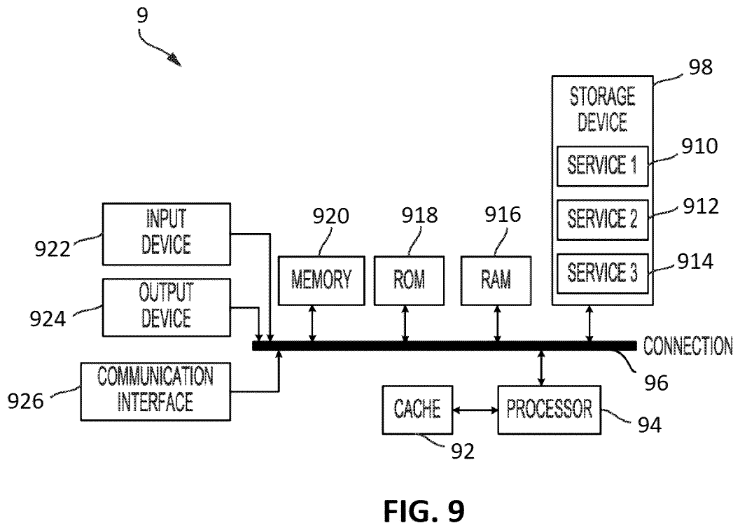

FIG. 9 illustrates an example computer system architecture 9 that includes various components in electrical communication with each other by means of electrical connection in the form of a bus 96 to carry out preferred embodiments of the invention. System 9 includes a processor 94 and a system connection 96 coupling system components including system memory 920 in the form of ROM 916 and RAM 918 to the processor 94. System 9 can include other types of memory including cache RAM 92 most preferably integrated as part of the processor 94.

Computer system 9 is configured to copy data from the memory 920 and/or a storage device 98 two cache RAM 92 to improve access by the processor 94 and thereby minimising data transmission delays. These memory elements, and in some preferred embodiments, other memory elements, are configured to control operation of the processor 94.

Other system memory 920 may be also be employed and can include multiple different types of memory with different performance characteristics. Similarly, the processor 94 can include any general purpose processor and a hardware or software service (eg service 1 910, service 2 912 & service 3 914 stored in storage device 98 that is configured to control the processor 94 as well as a special-purpose processor where software instructions are incorporated into the actual processor design. The processor 94 may be a completely self-contained computing system, containing multiple cores or processors, a bus, memory controller, cache, etc.

To enable user interaction with the computing system architecture 9, any preferred input device 922 can be used. Likewise, any preferred output device 924 can also be used. The storage device 98 is a non-volatile memory and can be a hard disk or other types of computer readable media which can store data that are accessible by a computer, such as magnetic cassettes, flash memory cards, solid state memory devices, digital versatile disks, cartridges, RAMs 916, ROM 918, for example. The storage device 98 can include services 910, 912, 914 for controlling the processor 94.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

In view of the foregoing it can be seen the system and method of the preferred embodiment provide a secure Detection & Response program by engaging independent subscriber analysts but also secure owner data.

It is understood the system and method address problems including the trust of the analyst community and implementation of the access criteria methodology that enables a data owner organisation to explicitly understand who they are engaging for detection capabilities as per their requirements. It also provides a scoring mechanism for the analyst community that supports the trust model for an organisation to decide who may access their telemetry data and provide the benefits of their expertise and is scalable and reliable processing environment that enables both organisations and analysts to meet in a low cost high capacity designed system with the bar lowered to enable each party to focus on their own outcomes with little impact to the other.

Further, the preferred embodiment also provides for a validatable approach that ensures accuracy, timeliness and completeness for submissions made by the analysts to companies, as well as providing a validation approach that ensures protections are in place against fabrication attacks with the goal of tricking an organisation into believing they are hacked when not so. Also, telemetry data processing is provided that is both scalable, reliable and capable in the steps taken to ensure privacy and security of the telemetry data is achieved while maintaining the integrity and usefulness from a security perspective of the telemetry data.

This invention enables for the safe and secure sharing of telemetry data for the purposes of cyber threat detection by 3rd parties to a given organisation where the data was produced. Today this is not performed at all in any way with the issues as described above that come with the reliance on 3rd parties to secure the systems and users that access the data. This mechanism prepares telemetry data in such a way that it can be shared with no detriment to the organisation itself while also not reducing the security value of the telemetry data for the purposes of identifying compromised technology assets through analytical means.

1. A method of detecting compromised digital assets of a data owner, the method comprising the steps of:
selecting a digital asset data of the data owner;
uploading selected owner data to a receiving system;
identifying, by said receiving system, predetermined data types of the uploaded owner data and performing on identified data types one or more selected sequentially from the group consisting of:
redacting owner specific data, scrubbing predetermined common data, and
tokenising predetermined data;
assessing and certifying the accuracy of the redaction, scrubbing and tokenisation of the data and producing prepared owner data; and
preferably enriching the prepared owner data;
defining, on the receiving system, reward rules for detection of compromised prepared owner data including a tangible reward;
subscribing one or more predetermined registered third party analysts to the prepared owner data;
receiving by the receiving system, from at least one subscribed analyst, a compromised data report indicating one or more compromises of the prepared data;
validating by the receiving system the received compromised data report;
sending, by the receiving system, data indicative of the compromised data report to the data owner; and
facilitated by the receiving system transfer of the reward to the subscribed analyst.

2. The method according to claim 1 wherein the owner transfers the tangible reward to the receiving system when defining the reward rules.

3. The method according to claim 2 wherein the receiving system holds the tangible reward directly or indirectly in escrow until the subscriber analyst compromised data report is validated.

4. The method according to claim 1 wherein the reward rules include defining a minimum predetermined level of trust, and/or skillset of the subscribing analysts.

5. The method according to claim 1 wherein the step of the receiving system validating the compromised data report further includes validation by the data owner.

6. The method according to claim 1 wherein the subscribed analyst compromised data report is assessed structurally, grammatically, technically and genuity.

7. The method according to claim 6 wherein the structural assessment includes verifying: the subscriber identity, the format of the compromised data report, and the data of the compromised data report matches the prepared owner data.

8. The method according to claim 1 including the step of remediating the owner data to remove one or more compromises.

9. The method according to claim 1 wherein the step of identifying predetermined data types includes the steps of defining existing data log identification routines and determining if an application has been previously defined, wherein the identification routines include assigned telemetry data.

10. The method according to claim 9 including the step of converting the owner data into an object wherein the original data is an element.

11. The method according to claim 10 wherein the step of redacting owner specific data includes the steps of predefining one or more redaction routines according to the object data wherein object data requiring redaction is identified and replaced with predetermined redacted data.

12. The method according to claim 11 wherein scrubbing predetermined common data further includes the steps of predefining one or more scrubbing routines according to the redacted object data wherein object data requiring scrubbing is identified and replaced with predetermined redacted data.

13. The method according to claim 12 wherein tokenising predetermined data includes the steps of predefining one or more scrubbing routines according to the redacted object data and determining if the scrubbing routine/s are applicable to the redacted object data and defining a token therefor, such that the token is associated with a data field and predetermined scrubbed data.

14. The method according to claim 13 wherein assessing and certifying the accuracy of the redaction includes the steps of identifying one or more predefined tokens associated with defined text types wherein telemetry data in object data is tokenised as a function of the defined text types such that an identified matching string is replaced by a token corresponding thereto.

15. The method according to claim 14 wherein enriching the certified owner data includes the step of determining predefined data strings in the certified owner data and associating predetermined text therewith.

16. A system for detecting compromised digital assets of a data owner, the system comprising:
at least one memory; and
at least one processor coupled to the at least one memory and configured to:
select a digital asset data of the data owner;
upload selected owner data to a remote receiving system;
identify, by said receiving system, predetermined data types of the uploaded owner data and perform on identified data types one or more selected sequentially from the group consisting of:
redact owner specific data, scrubbing predetermined common data, and
tokenise predetermined data;
assess and certify the accuracy of the redaction, scrubbing and tokenisation of the data and produce prepared owner data; and
enrich the prepared owner data;
define, on the receiving system, reward rules for detection of compromised prepared owner data including a tangible reward;
subscribe one or more predetermined registered third party analysts to the prepared owner data;
receive by the receiving system, from at least one subscribed analyst, a compromised data report indicating one or more compromises of the prepared data;
validate by the receiving system the received compromised data report;
send, by the receiving system, data indicative of the compromised data report to the data owner; and
facilitate by the receiving system transfer of the reward to the subscribed analyst.

17. The system according to claim 16 wherein the processor is further configured to remediate the owner data to remove one or more compromises.

18. The system according to claim 16 wherein the processor is further configured to identify predetermined data types including defining existing data log identification routines and determining if an application has been previously defined, wherein the identification routines include assigned telemetry data.

19. A non-transitory computer readable storage medium having embedded thereon a program, wherein the program is executable by a processor to perform a method of detecting compromised digital assets of a data owner, the method comprising:
selecting a digital asset data of the data owner;
uploading selected owner data to a receiving system;
identifying, by said receiving system, predetermined data types of the uploaded owner data and performing on identified data types one or more selected sequentially from the group consisting of:
redacting owner specific data, scrubbing predetermined common data, and
tokenising predetermined data;
assessing and certifying the accuracy of the redaction, scrubbing and tokenisation of the data and producing prepared owner data; and
preferably enriching the prepared owner data;
defining, on the receiving system, reward rules for detection of compromised prepared owner data including a tangible reward;
subscribing one or more predetermined registered third party analysts to the prepared owner data;
receiving by the receiving system, from at least one subscribed analyst, a compromised data report indicating one or more compromises of the prepared data;
validating by the receiving system the received compromised data report;
sending, by the receiving system, data indicative of the compromised data report to the data owner; and
facilitated by the receiving system transfer of the reward to the subscribed analyst.

20. The non-transitory computer readable storage medium according to claim 19, the method further comprising, for the step of identifying predetermined data types, the steps of defining existing data log identification routines and determining if an application has been previously defined, wherein the identification routines include assigned telemetry data.
